(19) United States
(12) Patent Application Publication
(10) Pub. No.: US 2010/0031976 A1
(43) Pub. Date: Feb. 11, 2010

(54) Detergent

(75) Inventors: Nadine Warkotsch, Duesseldorf (DE); Johannes Zipfel, Duesseldorf (DE); Arnd Kessler, Monheim (DE); Christian Nitsch, Duesseldorf (DE); Arno Dueffels, Duesseldorf (DE); Thomas Holderbaum, Hilden (DE)

Correspondence Address: Ratner Prestia, P.O. Box 980, Valley Forge, PA, 19482, US

(73) Assignee: Henkel AG & Co. KGaA, Duesseldorf (DE)

(21) Appl. No.: 12/536,885

(22) Filed: Aug. 6, 2009

Related U.S. Application Data
(63) Continuation of application No. PCT/EP2007/063328, filed on Dec. 5, 2007.

(30) Foreign Application Priority Data
Feb. 6, 2007 (DE) 10 2007 006 627.0

(51) Int. Cl. B08B 9/20; C11D 3/37

(52) U.S. Cl. 134/25.2; 510/230

(57) ABSTRACT

Phosphate-free automatic dishwashing agents containing a) citrate, b) sodium percarbonate, c) nonionic surfactant, d) copolymer encompassing i) monomers from the group of the mono- or polyunsaturated carboxylic acids, ii) monomers of the general formula R¹(R²)C═C(R³)—X—R⁴, in which R¹ to R³, mutually independently, denote —H, —CH₃, or —C₂H₅, X denotes an optionally present spacer group that is selected from —CH₂—, —C(O)O—, and —C(O)—NH—, and R⁴ denotes a straight-chain or branched saturated alkyl residue having 2 to 22 carbon atoms or an unsaturated, preferably aromatic residue having 6 to 22 carbon atoms, e) 0.05 to 1 wt % methylglycinediacetic acid, are notable for washing and rinsing results that are comparable or even superior to those of phosphate-containing automatic dishwashing agents.

### CROSS-REFERENCE TO RELATED APPLICATIONS

This application is a continuation under 35 U.S.C. §§120 and 365(c) of International Application PCT/EP2007/063328, filed on Dec. 5, 2007. This application also claims priority under 35 U.S.C. §119 of DE 10 2007 006 627.0 filed on Feb. 6, 2007. The disclosures of PCT/EP2007/063328 and DE 10 2007 006 627.0 are incorporated by reference in their entirety.

### BACKGROUND OF THE INVENTION

The present patent application describes detergents, in particular detergents for automatic washing of dishes. The subject matter of this application is, in particular, phosphate-free automatic dishwashing agents.

The demands made today on automatically washed dishes are often more stringent than those on manually washed dishes. After automatic washing, for example, the dishes are intended not only to be completely free of food residues but also, for example, to exhibit no whitish spots resulting from hard water or other mineral salts, which spots derive from dried water droplets in the absence of a wetting agent.

Modern automatic dishwashing agents meet these requirements by integrating washing, care-providing, water-softening, and rinsing-action active substances, and are known to consumers as, for example, “2 in 1” or “3 in 1” dishwashing agents. As a constituent that is essential for successful washing and rinsing, automatic dishwashing agents provided for individual end users contain detergency builders. These detergency builders on the one hand raise the alkalinity of the washing bath, fats and oils being emulsified and saponified with increasing alkalinity; and on the other hand decrease the water hardness of the washing bath by complexing the calcium ions contained in the aqueous bath. The alkali metal phosphates have proven to be particularly effective detergency builders, and for this reason form the principal constituent of the predominant number of commercially obtainable automatic dishwashing agents.

While phosphates are therefore highly prized in terms of their advantageous effect as a constituent of automatic dishwashing agents, their use is nevertheless not unproblematic from the standpoint of environmental protection, since a substantial portion of the phosphate passes via household wastewater into bodies of water and, in particular into non-flowing bodies of water (lakes and reservoirs), plays an objectionable role in overfertilizing them. As a consequence of this phenomenon (also called “eutrophication”), the use of pentasodium triphosphate in textile detergents has been considerably reduced by legislation in some countries, e.g. USA, Canada, Italy, Sweden, and Norway, and entirely prohibited in Switzerland. In Germany since 1984, detergents may contain no more than 20% of this detergency builder.

In addition to nitrilotriacetic acid, sodium aluminum silicates (zeolites) are principally used in textile detergents as phosphate replacement or exchange substances. These substances are, however, unsuitable for various reasons for use in automatic dishwashing agents. A number of replacement substances have therefore been discussed in the literature as alternatives to the alkali metal phosphates in automatic dishwashing agents; of these, the citrates are to be particularly emphasized.

Phosphate-free automatic dishwashing agents that, in addition to a citrate, further contain carbonates, bleaching agents, and enzymes are described, for example, in European Patents EP 662 117 B1 (Henkel KGaA) and EP 692 020 B1 (Henkel KGaA).

A further alternative to the alkali metal phosphates that is used as a sole detergency builder but preferably in combination with citrates is methylglycinediacetic acid (MGDA). MGDA-containing automatic dishwashing agents are described, for example, in European Patent EP 906 407 B1 (Reckitt Benckiser) or European Patent Application EP 1 113 070 A2 (Reckitt Benckiser).

Despite efforts so far, manufacturers of automatic dishwashing agents have not hitherto succeeded in making available phosphate-free automatic dishwashing agents that are comparable or even superior to phosphate-containing detergents in terms of their washing and rinsing performance and, in particular, their deposit-inhibiting performance. Such identity of performance is, however, a prerequisite for the successful market introduction of phosphate-free detergents, since the majority of end users, despite extensive public discussion of environmental policy topics, will always decide against an environmentally advantageous product if it does not meet market standards in terms of its price and/or performance.

### DESCRIPTION OF THE INVENTION

In view of this initial situation, the object of the present Application was therefore to make available a phosphate-free automatic dishwashing agent that is comparable or even superior to conventional phosphate-containing detergents both with regard to its washing performance and with regard to its rinsing results and its performance in terms of deposit inhibition.

It has been found that automatic dishwashing agents that, in addition to citrate, sodium percarbonate, and nonionic surfactants, also contain specific hydrophobically modified copolymers, with the addition of even small quantities of methylglycinediacetic acid and without the addition of alkali metal phosphates, exhibit outstanding deposit inhibition as well as outstanding washing and rinsing performance.

A first subject of the present application is therefore a phosphate-free automatic dishwashing agent containing
a) citrate,
b) sodium percarbonate,
c) nonionic surfactant,
d) copolymer encompassing
   i) monomers from the group of the mono- or polyunsaturated carboxylic acids,
   ii) monomers of the general formula R¹(R²)C═C(R³)—X—R⁴, in which R¹ to R³, mutually independently, denote —H, —CH₃, or —C₂H₅, X denotes an optionally present spacer group that is selected from —CH₂—, —C(O)O—, and —C(O)—NH—, and R⁴ denotes a straight-chain or branched saturated alkyl residue having 2 to 22 carbon atoms or an unsaturated, preferably aromatic residue having 6 to 22 carbon atoms,
   iii) if applicable, further monomers,
e) 0.05 to 1 wt % methylglycinediacetic acid.

A first characterizing constituent of agents according to the present invention is the citrate. The term “citrate” encompasses both citric acid and salts thereof, in particular alkali metal salts thereof. Particularly preferred automatic dishwashing agents according to the present invention contain citrate in quantities from 5 to 60 wt %, by preference 10 to 50 wt %, and in particular 15 to 40 wt %. Citrate and citric acid have proven particularly effective, in terms of both washing performance and rinsing performance, in combination with MGDA and the hydrophobically modified copolymers.

Phosphate-free automatic dishwashing agents containing
a) 5 to 60 wt %, by preference 10 to 50 wt %, and in particular 15 to 40 wt % citrate,
b) sodium percarbonate,
c) nonionic surfactant,
d) copolymer encompassing
   i. monomers from the group of the mono- or polyunsaturated carboxylic acids,
   ii. monomers of the general formula R¹(R²)C═C(R³)—X—R⁴, in which R¹ to R³, mutually independently, denote —H, —CH₃, or —C₂H₅, X denotes an optionally present spacer group that is selected from —CH₂—, —C(O)O—, and —C(O)—NH—, and R⁴ denotes a straight-chain or branched saturated alkyl residue having 2 to 22 carbon atoms or an unsaturated, preferably aromatic residue having 6 to 22 carbon atoms,
e) 0.05 to 1 wt % methylglycinediacetic acid
   are preferred according to the present invention.

Agents according to the present invention can of course also contain further detergency builders in addition to the citrate. Included among these detergency builders are, in particular, silicates, carbonates, and organic cobuilders.

Organic cobuilders that may be mentioned in particular are polycarboxylates/polycarboxylic acids, polymeric carboxylates, aspartic acid, polyacetates, dextrins, further organic cobuilders, and phosphonates. These substance classes are described below.

Usable organic builder substances are, for example, the polycarboxylic acids usable in the form of the free acid and/or their sodium salts, “polycarboxylic acids” being understood as those carboxylic acids that carry more than one acid function. These are, for example, adipic acid, succinic acid, glutaric acid, malic acid, tartaric acid, maleic acid, fumaric acid, sugar acids, aminocarboxylic acids, nitrilotriacetic acid (NTA), provided such use is not objectionable for environmental reasons, as well as mixtures thereof. The free acids typically also possess, in addition to their builder effect, the property of an acidifying component, and thus also serve to establish a lower and milder pH for washing or cleaning agents. Worthy of mention in this context are, in particular, succinic acid, glutaric acid, adipic acid, gluconic acid, and any mixtures thereof.

Automatic dishwashing agents according to the present invention preferably contain, as a detergency builder, crystalline sheet-form sodium silicates of the general formula NaMSiₓO₂ₓ₊₁.y H₂O, where M denotes sodium or hydrogen, x is a number from 1.9 to 22, by preference from 1.9 to 4, particularly preferred values for x being 2, 3, or 4, and y denotes a number from 0 to 30, by preference from 0 to 20.

Also usable are amorphous sodium silicates having a Na₂O:SiO₂ modulus from 1:2 to 1:3.3, by preference from 1:2 to 1:2.8, and in particular from 1:2 to 1:2.6, which preferably are dissolution-delayed and exhibit secondary washing characteristics.

In the context of the present invention, preferred automatic dishwashing agents contain 2 to 15 wt %, by preference 3 to 12 wt %, and in particular 4 to 8 wt % silicate(s).

It is particularly preferred to use carbonate(s) and/or hydrogencarbonate(s), by preference alkali carbonate(s), particularly preferably sodium carbonate, in quantities from 5 to 50 wt %, by preference from 10 to 40 wt %, and in particular from 15 to 30 wt %, based in each case on the weight of the automatic dishwashing agent.

Also suitable as detergency builders are polymeric polycarboxylates; these are, for example, the alkali metal salts of polyacrylic acid or polymethacrylic acid, for example those having a relative molecular weight from 500 to 70,000 g/mol.

Suitable polymers are, in particular, polyacrylates, which preferably have a molecular weight from 2000 to 20,000 g/mol. Because of their superior solubility, of this group the short-chain polyacrylates that have molecular weights from 2000 to 10,000 g/mol, and particularly preferably from 3000 to 5000 g/mol, may in turn be preferred.

Also suitable are copolymeric polycarboxylates, in particular those of acrylic acid with methacrylic acid and of acrylic acid or methacrylic acid with maleic acid. Copolymers of acrylic acid with maleic acid that contain 50 to 90 wt % acrylic acid and 50 to 10 wt % maleic acid have proven particularly suitable. Their relative molecular weight, based on free acids, is generally 2000 to 70,000 g/mol, by preference 20,000 to 50,000 g/mol, and in particular 30,000 to 40,000 g/mol.

The (co)polymeric polycarboxylates can be used as either a powder or an aqueous solution. The (co)polymeric polycarboxylate content of the automatic dishwashing agents is by preference 0.5 to 20 wt %, and in particular 3 to 10 wt %.

Additional suitable detergency builders are the phosphonates. The complex-forming phosphonates encompass a number of different compounds such as, for example, 1-hydroxyethane-1,1-diphosphonic acid (HEDP) or diethylenetriaminepenta(methylenephosphonic acid) (DTPMP). Hydroxyalkane- and aminoalkanephosphonates are preferred in particular in this Application. Among the hydroxyalkanephosphonates, 1-hydroxyethane-1,1-diphosphonate (HEDP) is of particular importance as a cobuilder. It is preferably used as a sodium salt, the disodium salt reacting neutrally and the tetrasodium salt in alkaline fashion (pH 9). Suitable aminoalkanephosphonates are, by preference, ethylenediaminetetramethylenephosphonate (EDTMP), diethylenetriaminepentamethylenephosphonate (DTPMP), and their higher homologs. They are preferably used in the form of the neutrally reacting sodium salts, e.g. as the hexasodium salt of EDTMP or as the hepta- and octasodium salt of DTPMP. Of the class of the phosphonates, HEDP is preferably used as a builder. The aminoalkanephosphonates furthermore possess a pronounced heavy-metal binding capability. It may accordingly be preferred, especially when the agents also contain bleaches, to use aminoalkanephosphonates, in particular DTPMP, or mixtures of the aforesaid phosphonates.

An automatic dishwashing agent that is preferred in this context of this Application contains one or more phosphonate(s) from the group of
a) aminotrimethylenephosphonic acid (ATMP) and/or salts thereof,
b) ethylenediaminetetra(methylenephosphonic acid) (EDTMP) and/or salts thereof,
c) diethylenetriaminepenta(methylenephosphonic acid) (DTPMP) and/or salts thereof,
d) 1-hydroxyethane-1,1-diphosphonic acid (HEDP) and/or salts thereof,
e) 2-phosphonobutane-1,2,4-tricarboxylic acid (PBTC) and/or salts thereof,
f) hexamethylenediaminetetra(methylenephosphonic acid) (HDTMP) and/or salts thereof,
g) nitrilotri(methylenephosphonic acid) (NTMP) and/or salts thereof.

Automatic dishwashing agents that contain 1-hydroxyethane-1,1-diphosphonic acid (HEDP) or diethylenetriaminepenta(methylenephosphonic acid) (DTPMP) as phosphonates are particularly preferred.

The automatic dishwashing agents according to the present invention can of course contain two or more different phosphonates. Those automatic dishwashing agents that contain, as phosphonates, both 1-hydroxyethane-1,1-diphosphonic acid (HEDP) and diethylenetriaminepenta(methylenephosphonic acid) DTPMP are particularly preferred, the weight ratio of HEDP to DTPMP being between 20:1 and 1:20, by preference between 15:1 and 1:15, and in particular between 10:1 and 1:10.

In a preferred embodiment of the present invention, the proportion by weight of the phosphonate(s) as a function of the total weight of the automatic dishwashing agent is less than the proportion by weight of the polymer(s) d). In other words, those agents in which the ratio of the proportion by weight of polymer d) to the proportion by weight of phosphonate is 200:1 to 2:1, preferably 150:1 to 2:1, particularly preferably 100:1 to 2:1, very particularly preferably 80:1 to 3:1, and in particular 50:1 to 5:1, are particularly preferred.

Automatic dishwashing agents according to the present invention additionally contain sodium percarbonate as a bleaching agent, automatic dishwashing agents that contain 1 to 20 wt %, by preference 2 to 15 wt %, and in particular 4 to 12 wt % sodium percarbonate being preferred according to the present invention.

Phosphate-free automatic dishwashing agents containing
a) citrate,
b) 1 to 20 wt %, by preference 2 to 15 wt %, and in particular 4 to 12 wt % sodium percarbonate,
c) nonionic surfactant,
d) copolymer encompassing
   i. monomers from the group of the mono- or polyunsaturated carboxylic acids,
   ii. monomers of the general formula R¹(R²)C═C(R³)—X—R⁴, in which R¹ to R³, mutually independently, denote —H, —CH₃, or —C₂H₅, X denotes an optionally present spacer group that is selected from —CH₂—, —C(O)O—, and —C(O)—NH—, and R⁴ denotes a straight-chain or branched saturated alkyl residue having 2 to 22 carbon atoms or an unsaturated, preferably aromatic residue having 6 to 22 carbon atoms,
e) 0.05 to 1 wt % methylglycinediacetic acid
   are preferred according to the present invention.

In order to achieve an improved bleaching effect when washing at temperatures of 60° C. and below, the automatic dishwashing agents according to the present invention can additionally contain bleach activators. Compounds that, under perhydrolysis conditions, yield aliphatic peroxycarboxylic acids having by preference 1 to 10 carbon atoms, in particular 2 to 4 carbon atoms, and/or optionally substituted perbenzoic acid, can be used as bleach activators. Substances that carry O- and/or N-acyl groups having the aforesaid number of carbon atoms, and/or optionally substituted benzoyl groups, are suitable. Multiply-acylated alkylenediamines are preferred; tetraacetylethylenediamine (TAED) has proven particularly suitable.

These bleach activators, in particular TAED, are used by preference in quantities up to 10 wt %, in particular 0.1 wt % to 8 wt %, particularly 2 to 8 wt %, and particularly preferably 2 to 6 wt %, based in each case on the total weight of the bleach activator-containing agent.

In addition to or instead of the conventional bleach activators, so-called bleach catalysts can also be used. These substances are bleach-enhancing transition-metal salts or transition-metal complexes such as, for example, Mn, Fe, Co, Ru, or Mo salt complexes or carbonyl complexes. Mn, Fe, Co, Ru, Mo, Ti, V, and Cu complexes having nitrogen-containing tripod ligands, as well as Co, Fe, Cu, and Ru amine complexes, are also usable as bleach catalysts.

It is particularly advantageous to use complexes of manganese in oxidation states II, III, IV, or IV, which by preference contain one or more macrocyclic ligand(s) having the donor functions N, NR, PR, O, and/or S. Ligands that comprise nitrogen donor functions are used by preference. It is particularly preferred in this context to use in the agents according to the present invention bleach catalyst(s) that contain 1,4,7-trimethyl-1,4,7-triazacyclononane (Me-TACN), 1,4,7-triazacyclononane (TACN), 1,5,9-trimethyl-1,5,9-triazacyclododecane (Me-TACD), 2-methyl-1,4,7-trimethyl-1,4,7-triazacyclononane (Me/Me-TACN), and/or 2-methyl-1,4,7-triazacyclononane (Me/TACN) as macromolecular ligands. Suitable manganese complexes are, for example, [Mn^{III}₂(μ-O)₁(μ-OAc)₂(TACN)₂](ClO₄)₂, [Mn^{III}Mn^{IV}(μ-O)₂(μ-OAc)₁(TACN)₂](BPh₄)₂, [Mn^{IV}₄(μ-O)₆(TACN)₄](ClO₄)₄, [Mn^{III}₂(μ-O)₁(μ-OAc)₂(Me-TACN)₂](ClO₄)₂, [Mn^{III}Mn^{IV}(μ-O)₁(μ-OAc)₂(Me-TACN)₂](ClO₄)₃, [Mn^{IV}₂(μ-O)₃(Me-TACN)₂](PF₆)₂, and [Mn^{IV}₂(μ-O)₃(Me/Me-TACN)₂](PF₆)₂(OAc═OC(O)CH₃).

Automatic dishwashing agents, characterized in that they further contain a bleach catalyst selected from the group of the bleach-enhancing transition metal salts and transition metal complexes, by preference from the group of the complexes of manganese with 1,4,7-trimethyl-1,4,7-triazacyclononane (Me₃-TACN) or 1,2,4,7-tetramethyl-1,4,7-triazacyclononane (Me₄-TACN), are preferred according to the present invention, since the washing result in particular can be significantly improved by means of the aforesaid bleach catalysts.

The aforesaid bleach-enhancing transition metal complexes, in particular having the central atoms Mn and Co, are used in usual quantities, by preference in a quantity of up to 5 wt %, in particular from 0.0025 wt % to 1 wt %, and particularly preferably from 0.01 wt % to 0.30 wt %, based in each case on the total weight of the bleach activator-containing agent. In specific cases, however, even more bleach activator can be used.

Phosphate-free automatic dishwashing agents containing
a) citrate,
b) sodium percarbonate,
c) nonionic surfactant,
d) copolymer encompassing
   i. monomers from the group of the mono- or polyunsaturated carboxylic acids,
   ii. monomers of the general formula R¹(R²)C═C(R³)—X—R⁴, in which R¹ to R³, mutually independently, denote —H, —CH₃, or —C₂H₅, X denotes an optionally present spacer group that is selected from —CH₂—, —C(O)O—, and —C(O)—NH—, and R⁴ denotes a straight-chain or branched saturated alkyl residue having 2 to 22 carbon atoms or an unsaturated, preferably aromatic residue having 6 to 22 carbon atoms,
e) 0.05 to 1 wt % methylglycinediacetic acid,
f) 0.01 to 1 wt % bleach-enhancing transition metal complex
   are therefore also preferred.

It has been found, surprisingly, that the bleaching action of bleach catalysts from the group of the bleach-enhancing transition metal salts and transition metal complexes can be increased by the addition of hydrophobically modified acid-containing copolymers.

A preferred subject of this Application is therefore a phosphate-free automatic dishwashing agent containing
a) citrate,
b) sodium percarbonate,
c) nonionic surfactant,
d) copolymer encompassing
   i. monomers from the group of the mono- or polyunsaturated carboxylic acids,
   ii. monomers of the general formula R¹(R²)C═C(R³)—X—R⁴, in which R¹ to R³, mutually independently, denote —H, —CH₃, or —C₂H₅, X denotes an optionally present spacer group that is selected from —CH₂—, —C(O)O—, and —C(O)—NH—, and R⁴ denotes a straight-chain or branched saturated alkyl residue having 2 to 22 carbon atoms or an unsaturated, preferably aromatic residue having 6 to 22 carbon atoms,
   iii. if applicable, further monomers,
e) 0.05 to 1 wt % methylglycinediacetic acid,
f) bleach catalyst selected from the group of the bleach-enhancing transition metal salts and transition metal complexes.

Several examples of formulations for phosphate-free automatic dishwashing agents preferred in this fashion may be gathered from the table below:

| | Formula 1 | Formula 2 | Formula 3 | Formula 4 |
|---|---|---|---|---|
| Ingredient | (wt %) | (wt %) | (wt %) | (wt %) |
| Citrate | 5 to 60 | 10 to 55 | 15 to 50 | 15 to 50 |
| Sodium | 1 to 20 | 2 to 15 | 4 to 10 | 4 to 10 |
| percarbonate | | | | |
| Bleach catalyst | 0.01 to 3 | 0.02 to 2 | 0.02 to 2 | 0.02 to 1 |
| Nonionic | 1 to 10 | 2 to 8 | 2 to 8 | 3 to 6 |
| surfactant | | | | |
| Copolymer¹ | 0.1 to 30 | 0.5 to 25 | 1.0 to 20 | 1.0 to 20 |
| MGDA | 0.05 to 1 | 0.05 to 1 | 0.05 to 1 | 0.05 to 1 |
| misc. | to make 100 | to make 100 | to make 100 | to make 100 |

¹Copolymer encompassing

i) monomers from the group of the mono- or polyunsaturated carboxylic acids,
ii) monomers of the general formula R¹(R²)C═C(R³)—X—R⁴, in which R¹ to R³, mutually independently, denote —H, —CH₃, or —C₂H₅, X denotes an optionally present spacer group that is selected from —CH₂—, —C(O)O—, and —C(O)—NH—, and R⁴ denotes a straight-chain or branched saturated alkyl residue having 2 to 22 carbon atoms or an unsaturated, preferably aromatic residue having 6 to 22 carbon atoms,
iii) if applicable, further monomers.

The agents according to the present invention furthermore contain surfactants. The nonionic, anionic, cationic, and amphoteric surfactants belong to the group of the surfactants.

Automatic dishwashing agents, characterized in that they contain nonionic surfactant(s) in quantities from 1 to 10 wt %, by preference 2 to 8 wt %, and in particular 3 to 6 wt %, are preferred according to the present invention.

All nonionic surfactants known to the skilled artisan can be used as nonionic surfactants. Suitable as nonionic surfactants, for example, are alkyl glycosides of the general formula RO(G)ₓ, in which R denotes a primary straight-chain or methyl-branched (in particular methyl-branched in the 2-position) aliphatic residue having 8 to 22, by preference 12 to 18 carbon atoms; and G is the symbol denoting a glycose unit having 5 or 6 carbon atoms, preferably glucose. The degree of oligomerization x, which indicates the distribution of monoglycosides and oligoglycosides, is any number between 1 and 10; by preference, x is between 1.2 and 1.4.

Nonionic surfactants of the amine oxide type, for example N-cocalkyl-N,N-dimethylamine oxide and N-tallowalkyl-N,N-dihydroxyethylamine oxide, and the fatty acid alkanolamides, can also be suitable. The quantity of these nonionic surfactants is by preference no more than that of the ethoxylated fatty alcohols, in particular no more than half thereof.

A further class of nonionic surfactants used in preferred fashion, which are used either as the only nonionic surfactant or in combination with other nonionic surfactants, are alkoxylated, preferably ethoxylated or ethoxylated and propoxylated, fatty acid alkyl esters, by preference having 1 to 4 carbon atoms in the alkyl chain, in particular fatty acid methyl esters.

Low-foaming nonionic surfactants are used as preferred surfactants. Particularly preferably, washing or cleaning agents, in particular detergents for automatic dishwashing, contain nonionic surfactants from the group of the alkoxylated alcohols. The nonionic surfactants used are preferably alkoxylated, advantageously ethoxylated, in particular primary alcohols having by preference 8 to 18 carbon atoms and an average of 1 to 12 mol ethylene oxide (EO) per mol of alcohol, in which the alcohol residue can be linear or preferably methyl-branched in the 2-position, or can contain mixed linear and methyl-branched residues, such as those that are usually present in oxo alcohol residues. Particularly preferred, however, are alcohol ethoxylates having linear residues made up of alcohols of natural origin having 12 to 18 carbon atoms, e.g. from coconut, palm, tallow, or oleyl alcohol, and an average of 2 to 8 EO per mol of alcohol. The preferred ethoxylated alcohols include, for example, C₁₂₋₁₄ alcohols with 3 EO or 4 EO, C₉₋₁₁ alcohols with 7 EO, C₁₃₋₁₅ alcohols with 3 EO, 5 EO, 7 EO, or 8 EO, C₁₂₋₁₈ alcohols with 3 EO, 5 EO, or 7 EO, and mixtures thereof, such as mixtures of C₁₂₋₁₄ alcohol with 3 EO and C₁₂₋₁₈ alcohol with 5 EO. The degrees of ethoxylation indicated represent statistical averages, which can correspond to an integral or a fractional number for a specific product. Preferred alcohol ethoxylates exhibit a narrow distribution of homologs (narrow range ethoxylates, NRE). In addition to these nonionic surfactants, fatty alcohols with more than 12 EO can also be used. Examples of these are tallow fatty alcohol with 14 EO, 25 EO, 30 EO, or 40 EO.

It is therefore particularly preferred to use ethoxylated nonionic surfactants that were obtained from C₆₋₂₀ monohydroxyalkanols or C₆₋₂₀ alkylphenols or C₁₆₋₂₀ fatty alcohols and more than 12 mol, by preference more than 15 mol, and in particular more than 20 mol ethylene oxide per mol of alcohol. A particularly preferred nonionic surfactant is obtained from a straight-chain fatty alcohol having 16 to 20 carbon atoms (C₁₆₋₂₀ alcohol), by preference a C₁₈ alcohol, and at least 12 mol, by preference at least 15 mol, and in particular at least 20 mol ethylene oxide. Among these, the so-called “narrow range ethoxylates” are particularly preferred.

It is furthermore particularly preferred to use combinations of one or more tallow fatty alcohols with 20 to 30 EO and silicone defoamers.

Nonionic surfactants that have a melting point above room temperature are particularly preferred. (A) nonionic surfactant(s) having a melting point above 20° C., by preference above 25° C., particularly preferably between 25 and 60° C., and in particular between 26.6 and 43.3° C., is/are particularly preferred.

Suitable nonionic surfactants that have melting or softening points in the aforesaid temperature range are, for example, low-foaming nonionic surfactants that can be solid or highly viscous at room temperature. When nonionic surfactants that are highly viscous at room temperature are used, it is then preferred that they have a viscosity above 20 Pa·s, by preference above 35 Pa·s, and in particular above 40 Pa·s. Nonionic surfactants that possess a waxy consistency at room temperature are also preferred depending on their intended application.

Nonionic surfactants from the group of the alkoxylated alcohols, particularly preferably from the group of the mixed alkoxylated alcohols, and in particular from the group of the EO-AO-EO nonionic surfactants, are likewise used with particular preference.

The nonionic surfactant that is solid at room temperature preferably possesses propylene oxide units in the molecule. Such PO units constitute by preference up to 25 wt %, particularly preferably up to 20 wt %, and in particular up to 15 wt % of the total molar weight of the nonionic surfactant. Particularly preferred nonionic surfactants are ethoxylated monohydroxyalkanols or alkylphenols that additionally comprise polyoxyethylene-polyoxypropylene block copolymer units. The alcohol or alkylphenol portion of such nonionic surfactant molecules constitutes by preference more than 30 wt %, particularly preferably more than 50 wt %, and in particular more than 70 wt % of the total molar weight of such nonionic surfactants. Preferred agents are characterized in that they contain ethoxylated and propoxylated nonionic surfactants in which the propylene oxide units in the molecule account for up to 25 wt %, preferably up to 20 wt %, and in particular up to 15 wt % of the total molar weight of the nonionic surfactant.

Nonionic surfactants that are preferred for use derive from the groups of the alkoxylated nonionic surfactants, in particular the ethoxylated primary alcohols, and mixtures of these surfactants with surfactants of greater structural complexity, such as polyoxypropylene/polyoxyethylene/polyoxypropylene (PO/EO/PO) surfactants. (PO/EO/PO) nonionic surfactants of this kind are moreover notable for good foam control.

Further nonionic surfactants having melting points above room temperature that are particularly preferred for use contain 40 to 70% of a polyoxypropylene/polyoxyethylene/polyoxypropylene block polymer blend that contains 75 wt % of a reverse block copolymer of polyoxyethylene and polyoxypropylene with 17 mol ethylene oxide and 44 mol propylene oxide, and 25 wt % of a block copolymer of polyoxyethylene and polyoxypropylene, initiated with trimethylolpropane and containing 24 mol ethylene oxide and 99 mol propylene oxide per mol of trimethylolpropane.

Low-foaming nonionic surfactants that comprise alternating ethylene oxide and alkylene oxide units have proven to be particularly preferred nonionic surfactants in the context of the present invention. Among these in turn, surfactants having EO-AO-EO-AO blocks are preferred, one to ten EO groups or AO groups being bound to one another in each case before being followed by a block of the respectively other groups. Preferred here are nonionic surfactants of the general formula

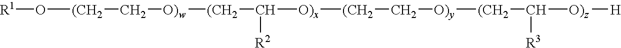

in which R¹ denotes a straight-chain or branched, saturated, or mono- or polyunsaturated C₆₋₂₄ alkyl or alkenyl residue; each R² and R³ group is selected, mutually independently, from —CH₃, —CH₂CH₃, —CH₂CH₂—CH₃, CH(CH₃)₂; and the indices w, x, y, and z, mutually independently, denote integers from 1 to 6.

The preferred nonionic surfactants of the above formula can be produced, using known methods, from the corresponding R¹—OH alcohols and ethylene oxide or alkylene oxide. The R¹ residue in the formula above can vary depending on the origin of the alcohol. When natural sources are used, the R¹ residue has an even number of carbon atoms and is generally unbranched, the linear residues from natural-origin alcohols having 12 to 18 carbon atoms, e.g. from coconut, palm, tallow, or oleyl alcohol, being preferred. Alcohols accessible from synthetic sources are, for example, the Guerbet alcohols or residues methyl-branched in the 2-position, or mixed linear and methyl-branched residues, such as those usually present in oxo alcohol residues. Regardless of the type of alcohol used to produce the nonionic surfactants contained in the agents, nonionic surfactants in which R¹ in the above formula denotes an alkyl residue having 6 to 24, by preference 8 to 20, particularly preferably 9 to 15, and in particular 9 to 11 carbon atoms, are preferred.

In addition to propylene oxide, butylene oxide in particular is possible as the alkylene oxide unit that is contained, alternatingly with the ethylene oxide unit, in the preferred nonionic surfactants. Also suitable, however, are further alkylene oxides in which R² and R³ are selected, mutually independently, from —CH₂CH₂—CH₃ and CH(CH₃)₂. It is preferred to use nonionic surfactants of the above formula in which R² and R³ denote a —CH₃ residue; w and x, mutually independently, denote values of 3 or 4; and y and z, mutually independently, denote values of 1 or 2.

In summary, nonionic surfactants that comprise a C₉₋₁₅ alkyl residue with 1 to 4 ethylene oxide units, followed by 1 to 4 propylene oxide units, followed by 1 to 4 ethylene oxide units, followed by 1 to 4 propylene oxide units, are particularly preferred. These surfactants exhibit the necessary low viscosity in aqueous solution, and are usable according to the present invention with particular preference.

Surfactants of the general formula R¹—CH(OH)CH₂O-(AO)_{w}-(A′O)ₓ-(A″O)_{y}-(A′″O)_{z}—R², in which R¹ and R², mutually independently, denote a straight-chain or branched, saturated or mono- or polyunsaturated C₂₋₄₀ alkyl or alkenyl residue; A, A′, A″, and A′″, mutually independently, denote a residue from the group —CH₂CH₂, —CH₂CH₂—CH₂, —CH₂—CH(CH₃), —CH₂—CH₂—CH₂—CH₂, —CH₂—CH(CH₃)—CH₂—, —CH₂—CH(CH₂—CH₃); and w, x, y, and z denote values between 0.5 and 90, wherein x, y, and/or z can also be 0, are preferred according to the present invention.

Particularly preferred are those end-capped poly(oxyalkylated) nonionic surfactants that, in accordance with the formula R¹O[CH₂CH₂O]ₓCH₂CH(OH)R², in addition to an R¹ residue that denotes linear or branched, saturated or unsaturated, aliphatic or aromatic hydrocarbon residues having 2 to 30 carbon atoms, preferably having 4 to 22 carbon atoms, additionally comprise a linear or branched, saturated or unsaturated, aliphatic or aromatic hydrocarbon residue R² having 1 to 30 carbon atoms, x denoting values between 1 and 90, by preference values between 30 and 80, and in particular values between 30 and 60.

Surfactants of the formula R¹O[CH₂CH(CH₃)O]ₓCH₂CH₂O]_{y}CH₂CH(OH)R², in which R¹ denotes a linear or branched aliphatic hydrocarbon residue having 4 to 18 carbon atoms or mixtures thereof, R² denotes a linear or branched hydrocarbon residue having 2 to 26 carbon atoms or mixtures thereof, and x denotes values between 0.5 and 15 and y denotes a value of at least 15, are particularly preferred.

The formation of deposits during automatic dishwashing can be considerably improved, as compared with conventional polyalkoxylated fatty alcohols without a free hydroxyl group, by the use of the above-described nonionic surfactants having a free hydroxyl group on one of the two terminal alkyl residues.

Additionally particularly preferred are those end-capped poly(oxyalkylated) nonionic surfactants of the formula R¹O[CH₂CH₂O]ₓ[CH₂CH(R³)O]_{y}CH₂CH(OH)R in which R¹ and R², mutually independently, denote a linear or branched, saturated or mono- or polyunsaturated hydrocarbon residue having 2 to 26 carbon atoms, R³ is selected, mutually independently, from —CH₃, —CH₂CH₃, —CH₂CH₂—CH₃, CH(CH₃)₂, but by preference denotes —CH₃, and x and y, mutually independently, denote values between 1 and 32, wherein nonionic surfactants in which R³═—CH₃, and having values from 15 to 32 for x and from 0.5 to 1.5 for y, are very particularly preferred.

Further nonionic surfactants that are preferred for use are the end-capped poly(oxyalkylated) nonionic surfactants of the formula R¹O[CH₂CH(R³)O]ₓ[CH₂]ₖCH(OH)[CH₂]ⱼOR² in which R¹ and R² denote linear or branched, saturated or unsaturated, aliphatic or aromatic hydrocarbon residues having 1 to 30 carbon atoms; R³ denotes H or a methyl, ethyl, n-propyl, isopropyl, n-butyl, 2-butyl, or 2-methyl-2-butyl residue; x denotes values between 1 and 30; and k and j denote values between 1 and 12, by preference between 1 and 5. If the value of x is greater than or equal to 2, each R³ in the above formula R¹O[CH₂CH(R³)O]ₓ[CH₂]ₖCH(OH)[CH₂]ⱼOR² can be different. R¹ and R² are preferably linear or branched, saturated or unsaturated, aliphatic or aromatic hydrocarbon residues having 6 to 22 carbon atoms, wherein residues having 8 to 18 carbon atoms are particularly preferred. For the R³ residue, H, —CH₃, or —CH₂CH₃ are particularly preferred. Particularly preferred values for x are in the range from 1 to 20, in particular from 6 to 15.

As described above, each R³ in the formula above can be different if x≧2. The alkylene oxide unit within square brackets can thereby be varied. If, for example, x denotes 3, the R³ residue can be selected so as to form ethylene oxide units (R³═H) or propylene oxide (R³═CH₃) units, which can be joined to one another in any sequence, for example (EO)(PO)(EO), (EO)(EO)(PO), (EO)(EO)(EO), (PO)(EO)(PO), (PO)(PO)(EO), and (PO)(PO)(PO). The value of 3 for x was selected here as an example, and can certainly be larger; the range of variation increases with rising values of x, and includes, for example, a large number of (EO) groups combined with a small number of (PO) groups, or vice versa.

Particularly preferred end-capped poly(oxyalkylated) alcohols of the above formula have values of k=1 and j=1, so that the formula above is simplified to R¹O[CH₂CH(R³)O]ₓCH₂CH(OH)CH₂OR². In the latter formula, R¹, R², and R³ are as defined above, and x denotes numbers from 1 to 30, by preference from 1 to 20, and in particular from 6 to 18. Surfactants in which the R¹ and R² residues have 9 to 14 carbon atoms, R³ denotes H, and x assumes values from 6 to 15, are particularly preferred.

The carbon chain lengths and degrees of ethoxylation or alkoxylation indicated for the aforesaid nonionic surfactants represent statistical averages that may be an integer or a fractional number for a specific product. As a result of production methods, commercial products of the aforesaid formulas are usually made up not of an individual representative but rather of mixtures, so that average values and, as a consequence, fractional numbers, can result both for the carbon chain lengths and for the degrees of ethoxylation and alkoxylation.

The aforesaid nonionic surfactants can of course be used not only as individual substances, but also as surfactant mixtures of two, three, four, or more surfactants. “Surfactant mixtures” refers not to mixtures of nonionic surfactants that fall, in their totality, under one of the aforesaid general formulas, but instead to those mixtures containing two, three, four, or more nonionic surfactants that can be described by different ones of the aforesaid general formulas.

Phosphate-free automatic dishwashing agents containing
a) citrate,
b) sodium percarbonate,
c) 1 to 10 wt %, by preference 2 to 8 wt %, and in particular 3 to 6 wt % nonionic surfactant,
d) copolymer encompassing
   i. monomers from the group of the mono- or polyunsaturated carboxylic acids,
   ii. monomers of the general formula R¹(R²)C═C(R³)—X—R⁴, in which R¹ to R³, mutually independently, denote —H, —CH₃, or —C₂H₅, X denotes an optionally present spacer group that is selected from —CH₂—, —C(O)O—, and —C(O)—NH—, and R⁴ denotes a straight-chain or branched saturated alkyl residue having 2 to 22 carbon atoms or an unsaturated, preferably aromatic residue having 6 to 22 carbon atoms,
e) 0.05 to 1 wt % methylglycinediacetic acid,
   are preferred according to the present invention.

A further essential constituent of automatic dishwashing agents according to the present invention is the hydrophobically modified copolymer d) encompassing monomers i) and ii).

It is particularly preferred to use, as monomers i) from the group of the mono- or polyunsaturated carboxylic acids, unsaturated carboxylic acids of the general formula R¹(R²)C═C(R³)COOH, in which R¹ to R³, mutually independently, denote —H, —CH₃, a straight-chain or branched saturated alkyl residue having 2 to 12 carbon atoms, a straight-chain or branched mono- or polyunsaturated alkenyl residue having 2 to 12 carbon atoms, alkyl or alkenyl residues as defined above substituted with —NH₂, —OH, or —COOH, or denote —COOH or —COOR⁴, wherein R⁴ is a saturated or unsaturated, straight-chain or branched hydrocarbon residue having 1 to 12 carbon atoms.

Phosphate-free automatic dishwashing agents containing
a) citrate,
b) sodium percarbonate,
c) nonionic surfactant,
d) copolymer encompassing
   i. monomers from the group of the carboxylic acids of the general formula R¹(R²)C═C(R³)COOH, in which R¹ to R³, mutually independently, denote —H, —CH₃, a straight-chain or branched saturated alkyl residue having 2 to 12 carbon atoms, a straight-chain or branched mono- or polyunsaturated alkenyl residue having 2 to 12 carbon atoms, alkyl or alkenyl residues as defined above substituted with —NH₂, —OH, or —COOH, or denote —COOH or —COOR⁴, wherein R⁴ is a saturated or unsaturated, straight-chain or branched hydrocarbon residue having 1 to 12 carbon atoms,
   ii. monomers of the general formula R¹(R²)C═C(R³)—X—R⁴, in which R¹ to R³, mutually independently, denote —H, —CH₃, or —C₂H₅, X denotes an optionally present spacer group that is selected from —CH₂—, —C(O)O—, and —C(O)—NH—, and R⁴ denotes a straight-chain or branched saturated alkyl residue having 2 to 22 carbon atoms or an unsaturated, preferably aromatic residue having 6 to 22 carbon atoms,
e) 0.05 to 1 wt % methylglycinediacetic acid,
   are preferred according to the present invention.

Particularly preferred carboxyl group-containing monomers i) are acrylic acid, methacrylic acid, ethacrylic acid, α-chloroacrylic acid, α-cyanoacrylic acid, crotonic acid, α-phenylacrylic acid, maleic acid, maleic acid anhydride, fumaric acid, itaconic acid, citraconic acid, methylenemalonic acid, sorbic acid, cinnamic acid, or mixtures thereof.

Monomers of the general formula R¹(R²)C═C(R³)—X—R⁴ are used as nonionic monomers ii). Particularly preferred monomers of this kind are butene, isobutene, pentene, 3-methylbutene, 2-methylbutene, cyclopentene, hexene, hexene-1,2-methlypentene-1,3-methlypentene-1, cyclohexene, methylcyclopentene, cycloheptene, methylcyclohexene, 2,4,4-trimethylpentene-1,2,4,4-trimethylpentene-2,2,3-dimethylhexene-1,2,4-dimethylhexene-1,2,5-dimethlyhexene-1,3,5-dimethylhexene-1,4,4-dimethylhexane-1, ethylcyclohexyne, 1-octene, α-olefins having 10 or more carbon atoms such as, for example, 1-decene, 1-dodecene, 1-hexadecene, 1-octadecene, and C22-α-olefin, 2-styrene, α-methylstyrene, 3-methylstyrene, 4-propylstryene, 4-cyclohexylstyrene, 4-dodecylstyrene, 2-ethyl-4-benzylstyrene, 1-vinylnaphthalene, 2-vinylnaphthalene, acrylic acid methyl ester, acrylic acid ethyl ester, acrylic acid propyl ester, acrylic acid butyl ester, acrylic acid pentyl ester, acrylic acid hexyl ester, methacrylic acid methyl ester, n-(methyl)acrylamide, acrylic acid 2-ethylhexyl ester, methacrylic acid 2-ethylhexyl ester, N-(2-ethylhexyl)acrylamide, acrylic acid octyl ester, methacrylic acid octyl ester, N-(octyl)acrylamide, acrylic acid lauryl ester, methacrylic acid lauryl ester, N-(lauryl)acrylamide, acrylic acid stearyl ester, methacrylic acid stearyl ester, N-(stearyl)acrylamide, acrylic acid behenyl ester, methacrylic acid behenyl ester, and N-(behenyl)acrylamide, or mixtures thereof.

Preferred automatic dishwashing agents according to the present invention in which the weight proportion of copolymer a) is 4 to 18 wt %, by preference 6 to 15, and in particular 6 to 12 wt %, have proven particularly effective in terms of optimum washing and rinsing results.

Phosphate-free automatic dishwashing agents containing
a) citrate,
b) sodium percarbonate,
c) nonionic surfactant,
d) 4 to 18 wt %, by preference 6 to 15, and in particular 8 to 12 wt % copolymer encompassing
   i. monomers from the group of the carboxylic acids of the general formula R¹(R²)C═C(R³)COOH, in which R¹ to R³, mutually independently, denote —H, —CH₃, a straight-chain or branched saturated alkyl residue having 2 to 12 carbon atoms, a straight-chain or branched mono- or polyunsaturated alkenyl residue having 2 to 12 carbon atoms, alkyl or alkenyl residues as defined above substituted with —NH₂, —OH, or —COOH, or denote —COOH or —COOR⁴, wherein R⁴ is a saturated or unsaturated, straight-chain or branched hydrocarbon residue having 1 to 12 carbon atoms,
   ii. monomers of the general formula R¹(R²)C═C(R³)—X—R⁴, in which R¹ to R³, mutually independently, denote —H, —CH₃, or —C₂H₅, X denotes an optionally present spacer group that is selected from —CH₂—, —C(O)O—, and —C(O)—NH—, and R⁴ denotes a straight-chain or branched saturated alkyl residue having 2 to 22 carbon atoms or an unsaturated, preferably aromatic residue having 6 to 22 carbon atoms,
e) 0.05 to 1 wt % methylglycinediacetic acid,
   are preferred according to the present invention.

In a particularly preferred embodiment, copolymer d) further encompasses, in addition to monomers i) and ii), a third monomer iii) from the group of the sulfonic acid group-containing monomers.

In the context of the sulfonic acid group-containing monomers, those of the formula

R⁵(R⁶)C═C(R⁷)—X—SO₃H,

in which R⁵ to R⁷, mutually independently, denote —H, —CH₃, a straight-chain or branched saturated alkyl residue having 2 to 12 carbon atoms, a straight-chain or branched, mono- or polyunsaturated alkenyl residue having 2 to 12 carbon atoms, alkyl or alkenyl residues as defined above substituted with —NH₂, —OH, or —COOH, or denote —COOH or —COOR⁴, wherein R⁴ is a saturated or unsaturated, straight-chain or branched hydrocarbon residue having 1 to 12 carbon atoms, and X denotes an optionally present spacer group that is selected from —(CH₂)ₙ— where n=0 to 4, —COO(CH₂)ₖ— where k=1 to 6, —C(O)—NH—C(CH₃)₂—, and —C(O)—NH—CH(CH₂CH₃)—, are preferred.

Among these monomers, those of the formulas

H₂C═CH—X—SO₃H

H₂C═C(CH₃)—X—SO₃H

HO₃S—X—(R⁶)C═C(R⁷)—X—SO₃—H,

in which R⁶ and R⁷, mutually independently, are selected from —H, —CH₃, —CH₂CH₃, —CH₂CH₂CH₃—, —CH(CH₃)₂, and X denotes an optionally present spacer group that is selected from —(CH₂)ₙ— where n=0 to 4, —COO(CH₂)ₖ— where k=1 to 6, —C(O)—NH—C(CH₃)₂—, and —C(O)—NH—CH(CH₂CH₃)—, are preferred.

Particularly preferred sulfonic acid group-containing monomers in this context are 1-acrylamido-1-propanesulfonic acid, 2-acrylamido-2-propanesulfonic acid, 2-acrylamido-2-methyl-1-propanesulfonic acid, 2-methacrylamido-2-methyl-1-propanesulfonic acid, 3-methacrylamido-2-hydroxypropanesulfonic acid, allylsulfonic acid, methallylsulfonic acid, allyloxybenzenesulfonic acid, methallyloxybenzenesulfonic acid, 2-hydroxy-3-(2-propenyloxy)propanesulfonic acid, 2-methyl-2-propene-1-sulfonic acid, styrenesulfonic acid, vinylsulfonic acid, 3-sulfopropylacrylate, 3-sulfopropylmethacrylate, sulfomethacrylamide, sulfomethylmethacrylamide, and mixtures of the aforesaid acids or water-soluble salts thereof.

The sulfonic acid groups can be present in the polymers entirely or partly in neutralized form, i.e. the acid hydrogen atom of the sulfonic acid group can, in some or all sulfonic acid groups, be exchanged for metal ions, by preference alkali metal ions, and in particular for sodium ions. The use of partly or entirely neutralized sulfonic acid group-containing copolymers is preferred according to the present invention.

The molar weight of the sulfocopolymers used in preferred fashion according to the present invention can be varied in order to adapt the properties of the polymers to the desired application. Preferred automatic dishwashing agents are characterized in that the copolymers have molar weights from 2000 to 200,000 gmol⁻¹, by preference from 4000 to 25,000 gmol⁻¹, and in particular from 5000 to 15,000 gmol⁻¹.

Phosphate-free automatic dishwashing agents containing
a) citrate,
b) sodium percarbonate,
c) nonionic surfactant,
d) copolymer encompassing
   i. monomers from the group of the mono- or polyunsaturated carboxylic acids,
   ii. monomers of the general formula R¹(R²)C═C(R³)—X—R⁴, in which R¹ to R³, mutually independently, denote —H, —CH₃, or —C₂H₅, X denotes an optionally present spacer group that is selected from —CH₂—, —C(O)O—, and —C(O)—NH—, and R⁴ denotes a straight-chain or branched saturated alkyl residue having 2 to 22 carbon atoms or an unsaturated, preferably aromatic residue having 6 to 22 carbon atoms,
   iii. sulfonic acid group-containing monomers,
e) 0.05 to 1 wt % methylglycinediacetic acid,
   are preferred according to the present invention.

Lastly, as the final essential constituent, the automatic dishwashing agents according to the present invention contain methylglycinediacetic acid (MGDA). Methylglycinediacetic acid can be present in the agents according to the present invention in the form of the free acid, as a partial neutralizate, or in completely neutralized fashion. In a particularly preferred embodiment, the methylglycinediacetic acid is present in the form of an alkali metal salt.

Methylglycinediacetic acid can be replaced, in the automatic dishwashing agents according to the present invention, by other alkylglycinediacetic acids of the general formula MOOC—CHR—N(CH₂COOM)₂ (R═H or C₂₋₁₂ alkyl; M, mutually independently, is H or alkali metal); methyglycinediacetic acid is, however, preferred for cost reasons.

The weight proportion of methyglycinediacetic acid e) in particularly preferred automatic dishwashing agents is 0.05 to 0.95 wt %, by preference 0.1 to 0.9 wt %, and in particular 0.2 to 0.8 wt %.

In summary, automatic dishwashing agents of the following basic formulations are particularly preferred in this Application:

A phosphate-free automatic dishwashing agent containing
a) 10 to 50 wt % citrate,
b) 2 to 15 wt % sodium percarbonate,
c) 2 to 8 wt % nonionic surfactant,
d) 6 to 15 wt % copolymer encompassing
   i. monomers from the group of the mono- or polyunsaturated carboxylic acids,
   ii. monomers of the general formula R¹(R²)C═C(R³)—X—R⁴, in which R¹ to R³, mutually independently, denote —H, —CH₃, or —C₂H₅, X denotes an optionally present spacer group that is selected from —CH₂—, —C(O)O—, and —C(O)—NH—, and R⁴ denotes a straight-chain or branched saturated alkyl residue having 2 to 22 carbon atoms or an unsaturated, preferably aromatic residue having 6 to 22 carbon atoms,
e) 0.1 to 0.9 wt % methylglycinediacetic acid,

A phosphate-free automatic dishwashing agent containing
a) 10 to 50 wt % citrate,
b) 2 to 15 wt % sodium percarbonate,
c) 2 to 8 wt % nonionic surfactant,
d) 6 to 15 wt % copolymer encompassing
   i. monomers from the group of the mono- or polyunsaturated carboxylic acids,
   ii. monomers of the general formula R¹(R²)C═C(R³)—X—R⁴, in which R¹ to R³, mutually independently, denote —H, —CH₃, or —C₂H₅, X denotes an optionally present spacer group that is selected from —CH₂—, —C(O)O—, and —C(O)—NH—, and R⁴ denotes a straight-chain or branched saturated alkyl residue having 2 to 22 carbon atoms or an unsaturated, preferably aromatic residue having 6 to 22 carbon atoms,
   iii. sulfonic acid group-containing monomers,
e) 0.1 to 0.9 wt % methylglycinediacetic acid.

In addition to the ingredients described earlier such as detergency builder, bleaching agent, nonionic surfactant, the copolymer a), and methylglycinediacetic acid, preferred automatic dishwashing agents contain further ingredients, by preference active substances from the group of the polymers, enzymes, corrosion inhibitors, fragrances, or dyes.

Included in the group of the polymers having washing or cleaning activity are, for example, the rinsing polymers and/or polymers effective as softeners. In addition to nonionic polymers, cationic, anionic, and amphoteric polymers are also generally usable in washing or cleaning agents.

“Cationic polymers” for purposes of the present invention are polymers that carry a positive charge in the polymer molecule. This can be implemented, for example, by way of (alkyl)ammonium groupings or other positively charged groups present in the polymer chain. Particularly preferred cationic polymers derive from the groups of the quaternized cellulose derivatives, polysiloxanes having quaternary groups, cationic guar derivatives, polymeric dimethyldiallylammonium salts and their copolymers with esters and amides of acrylic acid and methacrylic acid, copolymers of vinylpyrrolidone with quaternized derivatives of dialkylaminoacrylate and -methacrylate, vinylpyrrolidone/methoimidazolinium chloride copolymers, quaternized polyvinyl alcohols, or the polymers known by the INCI names Polyquaternium 2, Polyquaternium 17, Polyquaternium 18, and Polyquaternium 27.

“Amphoteric polymers” for purposes of the present invention further comprise, in addition to a positively charged group in the polymer chain, negatively charged groups or monomer units. These groups can be, for example, carboxylic acids, sulfonic acids, or phosphonic acids.

Preferred washing or cleaning agents, in particular preferred automatic dishwashing agents, are characterized in that they contain a polymer a) that comprises monomer units of the formula R¹R²C═CR³R⁴ in which each residue R¹, R², R³, R⁴ is selected, mutually independently, from hydrogen, a derivatized hydroxy group, C₁₋₃₀ linear or branched alkyl groups, aryl, aryl-substituted C₁₋₃₀ linear or branched alkyl groups, polyalkoxylated alkyl groups, heteroatomic organic groups having at least one positive charge without charged nitrogen, at least one quaternized nitrogen atom, or at least one amino group having a positive charge in the sub-range of the pH range from 2 to 11, or salts thereof, with the stipulation that at least one residue R¹, R², R³, R⁴ is a heteroatomic organic group having at least one positive charge without charged nitrogen, at least one quaternized nitrogen atom, or at least one amino group having a positive charge. Cationic or amphoteric polymers that are particularly preferred in the context of the present Application contain as a monomer unit a compound of the general formula

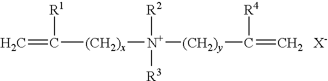

in which R¹ and R⁴, mutually independently, denote H or a linear or branched hydrocarbon residue having 1 to 6 carbon atoms; R² and R³, mutually independently, denote an alkyl, hydroxyalkyl, or aminoalkyl group in which the alkyl residue is linear or branched and comprises between 1 and 6 carbon atoms, this preferably being a methyl group; x and y, mutually independently, denote integers between 1 and 3. X⁻ represents a counterion, preferably a counterion from the group of chloride, bromide, iodide, sulfate, hydrogensulfate, methosulfate, lauryl sulfate, dodecylbenzenesulfonate, p-toluenesulfonate(tosylate), cumenesulfonate, xylenesulfonate, phosphate, citrate, formate, acetate, or mixtures thereof.

Preferred residues R¹ and R⁴ in the above formula are selected from CH₃, —CH₂—CH₃, —CH₂—CH₂—CH₃, —CH(CH₃)—CH₃, —CH₂—OH, —CH₂—CH₂—OH, —CH(OH)—CH₃, —CH₂—CH₂—CH₂—OH, —CH₂—CH(OH)—CH₃, —CH(OH)—CH₂—CH₃, and —(CH₂CH₂—O)ₙH.

Polymers that comprise a cationic monomer unit of the above general formula in which R¹ and R⁴ denote H, R² and R³ denote methyl, and x and y are each 1 are very particularly preferred. The corresponding monomer units of the formula

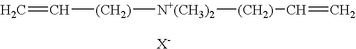

are also referred to, in the case in which X⁻=chloride, as DADMAC (diallyldimethylammonium chloride).

Further cationic or amphoteric polymers that are particularly preferred contain a monomer unit of the general formula

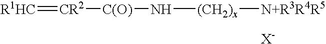

in which R¹, R², R³, R⁴ and R⁵, mutually independently, denote a linear or branched, saturated or unsaturated alkyl or hydroxyalkyl residue having 1 to 6 carbon atoms, preferably a linear or branched alkyl residue selected from CH₃, —CH₂—CH₃, —CH₂—CH₂—CH₃, —CH(CH₃)—CH₃, —CH₂—OH, —CH₂—CH₂—OH, —CH(OH)—CH₃, —CH₂—CH₂—CH₂—OH, —CH₂—CH(OH)—CH₃, —CH(OH)—CH₂—CH₃, and —(CH₂CH₂—O)ₙH, and x denotes an integer between 1 and 6.

Very particularly preferred in the context of the present Application are polymers that comprise a cationic monomer unit of the above general formula in which R¹ denotes H and R², R³, R⁴, and R⁵ denote methyl, and x denotes 3. The corresponding monomer units of the formula

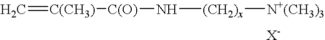

are also referred to, in the case where X⁻=chloride, as MAPTAC (methacrylamidopropyltrimethylammonium chloride).

Polymers that contain, as monomer units, diallyldimethylammonium salts and/or acrylamidopropyltrimethylammonium salts are preferred for use according to the present invention.

The aforementioned amphoteric polymers comprise not only cationic groups but also anionic groups or monomer units. Anionic monomer units of this kind derive, for example, from the group of the linear or branched, saturated or unsaturated carboxylates, the linear or branched, saturated or unsaturated phosphonates, the linear or branched, saturated or unsaturated sulfates, or the linear or branched, saturated or unsaturated sulfonates. Preferred monomer units are acrylic acid, (meth)acrylic acid, (dimethyl)acrylic acid, (ethyl)acrylic acid, cyanoacrylic acid, vinylacetic acid, allylacetic acid, crotonic acid, maleic acid, fumaric acid, cinnamic acid, and their derivatives, the allylsulfonic acids such as, for example, allyloxybenzenesulfonic acid and methallylsulfonic acid, or the allylphosphonic acids.

Amphoteric polymers preferred for use derive from the group of the alkylacrylamide/acrylic acid copolymers, the alkylacrylamide/methacrylic acid copolymers, the alkylacrylamide/methylmethacrylic acid copolymers, the alkylacrylamide/acrylic acid/alkylaminoalkyl(meth)acrylic acid copolymers, the alkylacrylamide/methacrylic acid/alkylaminoalkyl(meth)acrylic acid copolymers, the alkylacrylamide/methylmethacrylic acid/alkylaminoalkyl(meth)acrylic acid copolymers, the alkylacrylamide/alkylmethacrylate/alkylaminoethylmethacrylate/alkylmethacrylate copolymers, and the copolymers of unsaturated carboxylic acids, cationically derivatized unsaturated carboxylic acids and, if applicable, further ionic or nonionogenic monomers.

Zwitterionic polymers preferred for use derive from the group of the acrylamidoalkyltrialkylammonium chloride/acrylic acid copolymers and their alkali and ammonium salts, the acrylamidoalkyltrialkylammonium chloride/methacrylic acid copolymers and their alkali and ammonium salts, and the methacroylethylbetaine/methacrylate copolymers.

Also preferred are amphoteric polymers that encompass, in addition to one or more anionic monomers, methacrylamidoalkyltrialkylammonium chloride and dimethyl(diallyl)ammonium chloride as cationic monomers. Particularly preferred amphoteric polymers derive from the group of the methacrylamidoalkyltrialkylammonium chloride/dimethyl(diallyl)ammonium chloride/acrylic acid copolymers, the methacrylamidoalkyltrialkylammonium chloride/dimethyl(diallyl)ammonium chloride/methacrylic acid copolymers, and the methacrylamidoalkyltrialkylammonium chloride/dimethyl(diallyl)ammonium chloride/alkyl(meth)acrylic acid copolymers, as well as their alkali and ammonium salts. Particularly preferred are amphoteric polymers from the group of the methacrylamidopropyltrimethylammonium chloride/dimethyl(diallyl)ammonium chloride/acrylic acid copolymers, the methacrylamidopropyltrimethylammonium chloride/dimethyl(diallyl)ammonium chloride/acrylic acid copolymers, and the methacrylamidopropyltrimethylammonium chloride/dimethyl(diallyl)ammonium chloride/alkyl(meth)acrylic acid copolymers, as well as their alkali and ammonium salts.

In a particularly preferred embodiment of the present invention, the polymers are present in prepackaged form. Suitable for packaging of the polymers are, among others:
encapsulation of the polymers by means of water-soluble or water-dispersible coating agents, preferably by means of water-soluble or water-dispersible natural or synthetic polymers;
encapsulation of the polymers by means of water-insoluble meltable coating agents, preferably by means of water-insoluble coating agents from the group of the waxes or paraffins having a melting point above 30° C.;
cogranulation of the polymers with inert carrier materials, by preference with carrier materials from the group of the substances having washing or cleaning activity, particularly preferably from the group of the (detergency) builders or co-builders.

Washing or cleaning agents contain the aforesaid cationic and/or amphoteric polymers by preference in quantities between 0.01 and 10 wt %, based in each case on the total weight of the washing or cleaning agent. Those washing or cleaning agents in which the weight proportion of the cationic and/or amphoteric polymers is between 0.01 and 8 wt %, by preference between 0.01 and 6 wt %, preferably between 0.01 and 4 wt %, particularly preferably between 0.01 and 2 wt %, and in particular between 0.01 and 1 wt %, based in each case on the total weight of the automatic dishwashing agents, are nevertheless preferred in the context of the present Application.

Enzymes are usable in order to enhance the washing and cleaning performance of washing and cleaning agents, respectively. These include, in particular, proteases, amylases, lipases, hemicellulases, cellulases, perhydrolases, or oxidoreductases, as well as preferably mixtures thereof. These enzymes are, in principle, of natural origin; improved variants based on the natural molecules are available for use in washing and cleaning agents and are correspondingly preferred for use. Washing or cleaning agents contain enzymes by preference in total quantities from 1×10⁻⁶ to 5 wt %, based on active protein. The protein concentration can be determined with known methods, for example the BCA method or the biuret method.

Among the proteases, those of the subtilisin type are preferred. Examples thereof are the subtilisins BPN′ and Carlsberg and their further-developed forms, protease PB92, subtilisins 147 and 309, the alkaline protease from Bacillus lentus, subtilisin DY, and the enzymes (to be classified, however, as subtilases rather than as subtilisins in the strict sense) thermitase, proteinase K, and proteases TW3 and TW7.

Examples of amylases usable according to the present invention are the α-amylases from Bacillus licheniformis, B. amyloliquefaciens, B. stearothermophilus, Aspergillus niger, and A. oryzae, and the further developments of the aforesaid amylases improved for use in washing and cleaning agents. Additionally to be highlighted for this purpose are the α-amylase from Bacillus sp. A 7-7 (DSM 12368) and the cyclodextrin-glucanotransferase (CGTase) from B. agaradherens (DSM 9948).

Additionally usable according to the present invention are lipases or cutinases, in particular because of their triglyceride-cleaving activities but also in order to generate peracids in situ from suitable precursors. These include, for example, the lipases obtainable originally from Humicola lanuginosa (Thermomyces lanuginosus) or further-developed lipases, in particular those having the D96L amino acid exchange. Also usable, for example, are the cutinases that were originally isolated from Fusarium solani pisi and Humicola insolens. Also usable are lipases and cutinases whose starting enzymes were originally isolated from Pseudomonas mendocina and Fusarium solanii.

It is also possible to use enzymes that are grouped under the term “hemicellulases.” These include, for example, mannanases, xanthanlyases, pectinlyases (=pectinases), pectinesterases, pectatelyases, xyloglucanases (=xylanases), pullulanases, and β-glucanases.

To enhance the bleaching effect, according to the present invention oxidoreductases, for example oxidases, oxygenases, catalases, peroxidases such as halo-, chloro-, bromo-, lignin, glucose, or manganese peroxidases, dioxygenases, or laccases (phenoloxidases, polyphenoloxidases) can be used. Advantageously, preferably organic, particularly preferably aromatic compounds that interact with the enzymes are additionally added in order to enhance the activity of the relevant oxidoreductases (enhancers) or, if there is a large difference in redox potentials between the oxidizing enzymes and the stains, to ensure electron flow (mediators).

The enzymes can be used in any form established according to the existing art. These include, for example, the solid preparations obtained by granulation, extrusion, or lyophilization or, especially in the case of liquid or gelled agents, solutions of the enzymes, advantageously as concentrated as possible, anhydrous, and/or with stabilizers added.

Alternatively, the enzymes can be encapsulated for both the solid and the liquid administration form, for example by spray-drying or extruding the enzyme solution together with a preferably natural polymer, or in the form of capsules, for example ones in which the enzymes are enclosed e.g. in a solidified gel, or in those of the core-shell type, in which an enzyme-containing core is covered with a protective layer impermeable to water, air, and/or chemicals. Further active substances, for example stabilizers, emulsifiers, pigments, bleaching agents, or dyes, can additionally be applied in superimposed layers. Such capsules are applied in accordance with methods known per se, for example by vibratory or rolling granulation or in fluidized bed processes. Such granulates are advantageously low in dust, e.g. as a result of the application of polymeric film-forming agents, and are stable in storage thanks to the coating.

It is additionally possible to package two or more enzymes together, so that a single granulate exhibits several enzyme activities.

A protein and/or enzyme can be protected, especially during storage, from damage such as, for example, inactivation, denaturing, or decomposition, e.g. resulting from physical influences, oxidation, or proteolytic cleavage. An inhibition of proteolysis is particularly preferred in the context of microbial recovery of the proteins and/or enzymes, in particular when the agents also contain proteases. Washing or cleaning agents can contain stabilizers for this purpose; the provision of such agents represents a preferred embodiment of the present invention.

Preferably one or more enzymes and/or enzyme preparations, by preference solid protease preparations and/or amylase preparations, are used, in quantities from 0.1 to 5 wt %, by preference from 0.2 to 5 wt %, and in particular from 0.4 to 5 wt %, based in each case on the entire enzyme-containing agent.

Phosphate-free automatic dishwashing agents containing
a) 10 to 50 wt % citrate,
b) 2 to 15 wt % sodium percarbonate,
c) 2 to 8 wt % nonionic surfactant,
b) 6 to 15 wt % copolymer encompassing
   i. monomers from the group of the mono- or polyunsaturated carboxylic acids,
   ii. monomers of the general formula R¹(R²)C═C(R³)—X—R⁴, in which R¹ to R³, mutually independently, denote —H, —CH₃, or —C₂H₅, X denotes an optionally present spacer group that is selected from —CH₂—, —C(O)O—, and —C(O)—NH—, and R⁴ denotes a straight-chain or branched saturated alkyl residue having 2 to 22 carbon atoms or an unsaturated, preferably aromatic residue having 6 to 22 carbon atoms,
c) 0.1 to 0.9 wt % methylglycinediacetic acid,
d) 1.0 to 6 wt % enzyme,
   and
   phosphate-free automatic dishwashing agents containing
a) 10 to 50 wt % citrate,
b) 2 to 15 wt % sodium percarbonate,
c) 2 to 8 wt % nonionic surfactant,
d) 6 to 15 wt % copolymer encompassing
   i) monomers from the group of the mono- or polyunsaturated carboxylic acids,
   ii) monomers of the general formula R¹(R²)C═C(R³)—X—R⁴, in which R¹ to R³, mutually independently, denote —H, —CH₃, or —C₂H₅, X denotes an optionally present spacer group that is selected from —CH₂—, —C(O)O—, and —C(O)—NH—, and R⁴ denotes a straight-chain or branched saturated alkyl residue having 2 to 22 carbon atoms or an unsaturated, preferably aromatic residue having 6 to 22 carbon atoms,
   iii) sulfonic acid group-containing monomers,
e) 0.1 to 0.9 wt % methylglycinediacetic acid,
f) 1.0 to 6 wt % enzyme
   are very particularly preferred.

Some examples of formulas for preferred phosphate-free automatic dishwashing agents of this kind may be gathered from the tables below:

| | Formula 5 | Formula 6 | Formula 7 | Formula 8 |
|---|---|---|---|---|
| Ingredient | (wt %) | (wt %) | (wt %) | (wt %) |
| Citrate | 5 to 60 | 10 to 55 | 15 to 50 | 15 to 50 |
| Sodium | 1 to 20 | 2 to 15 | 4 to 10 | 4 to 10 |
| percarbonate | | | | |
| Enzyme | 0.1 to 6 | 0.2 to 5 | 0.4 to 5 | 0.4 to 5 |
| Copolymer¹ | 0.1 to 30 | 0.5 to 25 | 1.0 to 20 | 1.0 to 20 |
| MGDA | 0.05 to 1 | 0.05 to 1 | 0.05 to 1 | 0.05 to 1 |
| Nonionic | 1 to 10 | 2 to 8 | 2 to 8 | 3 to 6 |
| surfactant | | | | |
| Misc. | to make 100 | to make 100 | to make 100 | to make 100 |
| | Formula 9 | Formula 10 | Formula 11 | Formula 12 |
| Ingredient | (wt %) | (wt %) | (wt %) | (wt %) |
| Citrate | 5 to 60 | 10 to 55 | 15 to 50 | 15 to 50 |
| Carbonate/ | 2 to 40 | 2 to 40 | 2 to 40 | 2 to 40 |
| hydrogen- | | | | |
| carbonate | | | | |
| Silicate | 0 to 15 | 0 to 15 | 0 to 15 | 0.1 to 10 |
| Phosphonate | 0 to 14 | 0 to 14 | 0 to 14 | 2 to 8 |
| Sodium | 1 to 20 | 2 to 15 | 4 to 10 | 4 to 10 |
| percarbonate | | | | |
| Bleach catalyst | 0.01 to 3 | 0.02 to 2 | 0.02 to 2 | 0.02 to 1 |
| Copolymer¹ | 0.1 to 30 | 0.5 to 25 | 1.0 to 20 | 1.0 to 20 |
| MGDA | 0.5 to 20 | 0.5 to 20 | 0.5 to 10 | 0.5 to 8 |
| Nonionic | 1 to 10 | 2 to 8 | 2 to 8 | 3 to 6 |
| surfactant | | | | |
| Enzyme | 0.1 to 6 | 0.2 to 5 | 0.4 to 5 | 0.4 to 5 |
| Misc. | to make 100 | to make 100 | to make 100 | to make 100 |

¹Copolymer encompassing

i) monomers from the group of the mono- or polyunsaturated carboxylic acids,
ii) monomers of the general formula R¹(R²)C═C(R³)—X—R⁴ in which R¹ to R³, mutually independently, denote —H, —CH₃, or —C₂H₅, X denotes an optionally present spacer group that is selected from —CH₂—, —C(O)O—, and —C(O)—NH—, and R⁴ denotes a straight-chain or branched saturated alkyl residue having 2 to 22 carbon atoms or an unsaturated, preferably aromatic residue having 6 to 22 carbon atoms,
iii) if applicable, further monomers.

Glass corrosion inhibitors prevent the occurrence of clouding, smearing, and scratches, but also iridescence, on the glass surface of automatically washed glassware. Preferred glass corrosion inhibitors derive from the group of the magnesium and zinc salts and the magnesium and zinc complexes.

The spectrum of zinc salts, by preference of organic acids, particularly preferably of organic carboxylic acids, that are preferred according to the present invention extends from salts that are poorly soluble or insoluble in water, i.e. exhibit a solubility below 100 mg/l, preferably below 10 mg/l, in particular below 0.01 mg/l, to those salts that exhibit a solubility in water above 100 mg/l, by preference above 500 mg/l, particularly preferably above 1 g/l, and in particular above 5 g/l (all solubilities at a water temperature of 20° C.). Zinc citrate, zinc oleate, and zinc stearate, for example, belong to the first group of zinc salts; zinc formate, zinc acetate, zinc lactate, and zinc gluconate, for example, belong to the group of the soluble zinc salts.

At least one zinc salt of an organic carboxylic acid, particularly preferably a zinc salt from the group of zinc stearate, zinc oleate, zinc gluconate, zinc acetate, zinc lactate, and/or zinc citrate, is used with particular preference as a glass corrosion inhibitor. Zinc ricinoleate, zinc abietate, and zinc oxalate are also preferred.

In the context of the present invention, the zinc salt concentration in washing or cleaning agents is by preference between 0.1 and 5 wt %, preferably between 0.2 and 4 wt %, and in particular between 0.4 and 3 wt %, or the concentration of zinc in oxidized form (calculated as Zn²⁺) is between 0.01 and 1 wt %, by preference between 0.02 and 0.5 wt %, and in particular between 0.04 and 0.5 wt %, based in each case on the total weight of the glass corrosion inhibitor-containing agent.

Corrosion inhibitors serve to protect the items being washed or the machine, silver protection agents having particular importance in the automatic dishwashing sector. The known substances of the existing art are usable. In general, silver protection agents can be selected principally from the group of the triazoles, benzotriazoles, bisbenzotriazoles, aminotriazoles, alkylaminotriazoles, and transition-metal salts or complexes. It is particularly preferred to use benzotriazole and/or alkylaminotriazole. It is preferred according to the present invention to use 3-amino-5-alkyl-1,2,4-triazoles or their physiologically acceptable salts, these substances being used with particular preference at a concentration from 0.001 to 10 wt %, preferably 0.0025 to 2 wt %, particularly preferably 0.01 to 0.04 wt %.

In order to facilitate the breakdown of prefabricated shaped elements, it is possible to incorporate disintegration adjuvants, so-called tablet bursting agents, into these agents in order to shorten breakdown times.

These substances, which because of their action are also referred to as “bursting” agents, increase in volume upon the entry of water; on the one hand, their own volume is increased (swelling), and on the other hand the release of gases can also generate a pressure that allows the tablets to break down into smaller particles. Familiar disintegration adjuvants are, for example, carbonate/citric acid systems; other organic acids can also be used. Swelling disintegration adjuvants are, for example, synthetic polymers such as polyvinylpyrrolidone (PVP), or natural polymers or modified natural substances such as cellulose and starch and their derivates, alginates, or casein derivatives.

Disintegration adjuvants are preferably used in quantities from 0.5 to 10 wt %, by preference 3 to 7 wt %, and in particular 4 to 6 wt %, based in each case on the total weight of the disintegration adjuvant-containing agent.

Cellulose-based disintegration agents are used as preferred disintegration agents, so that preferred washing or cleaning agents contain such a cellulose-based disintegration agent in quantities from 0.5 to 10 wt %, by preference 3 to 7 wt %, and in particular 4 to 6 wt %. The cellulose used as a disintegration adjuvant is preferably not used in finely divided form, but instead is converted into a coarser form, for example granulated or compacted, before being mixed into the premixtures that are to be compressed. The particle sizes of such disintegration agents are usually above 200 μm, by preference at least 90 wt % between 300 and 1600 μm, and in particular at least 90 wt % between 400 and 1200 μm.

Preferred disintegration adjuvants, by preference a cellulose-based disintegration adjuvant, by preference in granular, cogranulated, or compacted form, are contained in the disintegration agent-containing agents in quantities from 0.5 to 10 wt %, by preference from 3 to 7 wt %, and in particular from 4 to 6 wt %, based in each case on the total weight of the disintegration agent-containing agent.

Gas-evolving effervescence systems can furthermore be used, in a manner preferred according to the present invention, as tablet disintegration adjuvants. The gas-evolving effervescence system can be made up of a single substance that releases a gas upon contact with water. To be mentioned among these compounds is, in particular, magnesium peroxide, which releases oxygen upon contact with water. Preferred effervescence systems, however, are made up of at least two constituents that react with one another to form gas, for example an alkali-metal carbonate and/or hydrogencarbonate as well as an acidifying agent that is suitable for releasing carbon dioxide from the alkali-metal salts in aqueous solution. Boric acid, as well as alkali-metal hydrogensulfates, alkali-metal dihydrogenphosphates, and other inorganic salts are usable, for example, as acidifying agents that release carbon dioxide from the alkali salts in aqueous solution. Organic acidifying agents are preferably used, however, citric acid being a particularly preferred acidifying agent. Acidifying agents in the effervescence system from the group of the organic di-, tri- and oligocarboxylic acids, or mixtures, are preferred.

Individual odorant compounds, e.g. the synthetic products of the ester, ether, aldehyde, ketone, alcohol, and hydrocarbon types, can be used as perfume oils or fragrances in the context of the present invention. Preferably, however, mixtures of different odorants that together produce an attractive fragrance note are used. Such perfume oils can also contain natural odorant mixtures such as those accessible from plant sources, for example pine, citrus, jasmine, patchouli, rose, or ylang-ylang oil.

The fragrances can be processed directly, but it may also be advantageous to apply the fragrances onto carriers that ensure a slower scent release for a lasting scent. Cyclodextrins, for example, have proven successful as such carrier materials; the cyclodextrin-perfume complexes can additionally be coated with further adjuvants.

Preferred dyes, the selection of which will present no difficulty whatsoever to the skilled artisan, possess excellent shelf stability and insensitivity to the other ingredients of the agents and to light, and no pronounced substantivity with respect to the substrates, for example textiles, glass, ceramic, or plastic tableware, to be treated with the dye-containing agents, in order not to color them.

The automatic dishwashing agents according to the present invention can be prepared in solid or liquid form but also, for example, as a combination of solid and liquid presentation forms.

Powders, granulates, extrudates, or compactates, in particular tablets, are especially suitable as solid presentation forms. The liquid presentation forms based on water and/or organic solvents can be presented in thickened form as gels.

Agents according to the present invention can be packaged as single-phase or multi-phase products. Automatic dishwashing agents having one, two, three, or four phases, in particular, are preferred. Automatic dishwashing agents, characterized in that they are present in the form of a prefabricated dispensing unit having two or more phases, are particularly preferred.

The individual phases of multi-phase agents can exhibit the same or different aggregate states. Automatic dishwashing agents that comprise at least two different solid phases and/or at least two liquid phases and/or at least one solid and at least one liquid phase, are particularly preferred.

Automatic dishwashing agents according to the present invention are preferably prepackaged into dispensing units. These dispensing units preferably encompass the quantity of substances having washing or cleaning activity that is necessary for one washing cycle. Preferred dispensing units have a weight between 12 and 30 g, preferably between 14 and 26 g, and in particular between 15 and 22 g.

Particularly preferably, the volume of the aforementioned dispensing units, and their three-dimensional shape, are selected so that dispensability of the prepackaged units via the dispensing chamber of an automatic dishwasher is guaranteed. The volume of the dispensing unit is therefore preferably between 10 and 35 ml, by preference between 12 and 30 ml, and in particular between 15 and 25 ml.

The automatic dishwashing agents according to the present invention, in particular the prepackaged dispensing units, particularly preferably comprise a water-soluble casing.

A further subject of the present invention is a method for washing dishes in an automatic dishwasher with the use of automatic dishwashing agents according to the present invention, wherein the automatic dishwashing agent is by preference dispensed into the interior of an automatic dishwasher during the execution of a dishwashing program, before the beginning of the main washing cycle, or in the course of the main washing cycle. Dispensing or introduction of the agent according to the present invention into the interior of the automatic dishwasher can occur manually, but by preference the agent is dispensed into the interior of the automatic dishwasher by means of the dispensing chamber of the automatic dishwasher. By preference, no additional water softener and no additional rinse agent is dispensed into the interior of the automatic dishwasher in the course of the washing process.

As described initially, the agents according to the present invention are notable for an improved rinsing effect as compared with conventional automatic dishwashing agents. The use of an automatic dishwashing agent according to the present invention as a rinse agent in automatic dishwashing is therefore a further subject of the present Application.

While particular embodiments of the present invention have been illustrated and described, it would be obvious to those skilled in the art that various other changes and modifications can be made without departing from the spirit and scope of the invention.

Other than where otherwise indicated, or where required to distinguish over the prior art, all numbers expressing quantities of ingredients herein are to be understood as modified in all instances by the term “about”. As used herein, the words “may” and “may be” are to be interpreted in an open-ended, non-restrictive manner. At minimum, “may” and “may be” are to be interpreted as definitively including, but not limited to, the composition, structure, or act recited.

As used herein, and in particular as used herein to define the elements of the claims that follow, the articles “a” and “an” are synonymous and used interchangeably with “at least one” or “one or more,” disclosing or encompassing both the singular and the plural, unless specifically defined herein otherwise. The conjunction “or” is used herein in both in the conjunctive and disjunctive sense, such that phrases or terms conjoined by “or” disclose or encompass each phrase or term alone as well as any combination so conjoined, unless specifically defined herein otherwise.

The description of a group or class of materials as suitable or preferred for a given purpose in connection with the invention implies that mixtures of any two or more of the members of the group or class are equally suitable or preferred. Description of constituents in chemical terms refers unless otherwise indicated, to the constituents at the time of addition to any combination specified in the description, and does not necessarily preclude chemical interactions among the constituents of a mixture once mixed. Steps in any method disclosed or claimed need not be performed in the order recited, except as otherwise specifically disclosed or claimed.

Changes in form and substitution of equivalents are contemplated as circumstances may suggest or render expedient. Although specific terms have been employed herein, such terms are intended in a descriptive sense and not for purposes of limitation.

The following Examples further illustrate the preferred embodiments within the scope of the present invention, but are not intended to be limiting thereof. It is understood that the examples and embodiments described herein are for illustrative purposes only and that various modifications or changes in light thereof will be suggested to one skilled in the art without departing from the scope of the present invention. The appended claims therefore are intended to cover all such changes and modifications that are within the scope of this invention.

### Examples

In a first washing experiment, dirty dishes were washed in an automatic dishwasher using 21 g of a commercially usual phosphate-containing automatic dishwashing agent V1, with 21 g of a phosphate-free automatic dishwashing agent containing high MGDA content V2, and with 21 g of the phosphate-free automatic dishwashing agent E1, at a water hardness of 21° dH.

The composition of the dishwashing agents used may be gathered from the following table:

| Raw material | V1 | V2 | E1 |
|---|---|---|---|
| Phosphate | 33 | — | — |
| Citrate | — | 23 | 23 |
| MGDA | — | 8 | 0.5 |
| Copolymer¹ | 12.0 | 12.0 | 12.0 |
| HEDP | 2.0 | — | — |
| Soda | 28.0 | 28.0 | 28.0 |
| Sodium percarbonate | 10.0 | 10.0 | 10.0 |
| TAED | 2.4 | 2.4 | 2.4 |
| Protease/amylase | 4.0 | 4.0 | 4.0 |
| Nonionic surfactant | 5.0 | 5.0 | 5.0 |
| Misc. | to make 100 | to make 100 | to make 100 |

¹Hydrophobically modified copolymer

The overall appearance of the washed items was assessed using the scoring scale presented below. The results are indicated in the table that follows (values indicated are averages of three experiments):

| | V1 | V2 | E1 |
|---|---|---|---|
| Washing result | 8.1 | 7.8 | 7.9 |
| Deposit formation | | Glass 2.0 | Glass 2.8 |
| | | China 3.0 | China 3.0 |

Scoring scale for washing: 10=no soiling to 0=severe soiling (average of seven specific dirt types)

Scoring scale for rinsing: 10=no droplet formation to 0=severe droplet formation.

What is claimed:

1. A phosphate-free automatic dishwashing agent comprising:
a) a citrate;
b) sodium percarbonate;
c) a nonionic surfactant;
d) a copolymer comprising:
i) a mono- or polyunsaturated carboxylic acid monomer; and
ii) a monomer of the general formula R¹(R²)C═C(R³)—X—R⁴, in which R¹ to R³₁ mutually independently, denote —H, —CH₃, or —C₂H₅, X denotes an optionally present spacer group that is selected from —CH₂—, —C(O)O—, and —C(O)—NH—, and R⁴ denotes a straight-chain or branched saturated alkyl residue having 2 to 22 carbon atoms or an unsaturated, optionally aromatic residue having 6 to 22 carbon atoms; and
iii) optionally one or more further monomers; and
e) 0.05% to 1% by weight methylglycinediacetic acid.

2. The automatic dishwashing agent of claim 1, comprising 5% to 60% by weight of the citrate.

3. The automatic dishwashing agent of claim 1, comprising 1% to 20% by weight of the sodium percarbonate.

4. The automatic dishwashing agent of claim 1, further comprising a bleach catalyst comprising a bleach-intensifying transition metal salt or transition metal complex.

5. The automatic dishwashing agent of claim 4, wherein the bleach catalyst comprises 1,4,7-trimethyl-1,4,7-triazacyclononane (Me₃-TACN) or 1,2,4,7-tetramethyl-1,4,7-triazacyclononane (Me₄-TACN).

6. The automatic dishwashing agent of claim 1, comprising 1% to 10% by weight of the nonionic surfactant.

7. The automatic dishwashing agent of claim 1, comprising 4% to 18% by weight of the copolymer d).

8. The automatic dishwashing agent of claim 1, wherein copolymer d) comprises as the one or more monomers iii) a sulfonic acid group-containing monomer.

9. The automatic dishwashing agent of claim 1, comprising 0.05% to 0.95% by weight of the methylglycinediacetic acid.

10. The automatic dishwashing agent of claim 1, comprising:
a) 10% to 50% by weight of the citrate;
b) 2% to 15% by weight of the sodium percarbonate;
c) 2% to 8% by weight of the nonionic surfactant;
d) 6% to 15% by weight of the copolymer comprising
i) a mono- or polyunsaturated carboxylic acid monomer; and
ii) a monomer of the general formula R¹(R²)C═C(R³)—X—R⁴, in which R¹ to R³, mutually independently, denote —H, —CH₃, or —C₂H₅, X denotes an optionally present spacer group that is selected from —CH₂—, —C(O)O—, and —C(O)—NH—, and R⁴ denotes a straight-chain or branched saturated alkyl residue having 2 to 22 carbon atoms or an unsaturated, optionally aromatic residue having 6 to 22 carbon atoms; and
e) 0.1% to 0.9% by weight of the methylglycinediacetic acid.

11. The automatic dishwashing agent of claim 1, comprising:
a) 10% to 50% by weight of the citrate;
b) 2% to 15% by weight of the sodium percarbonate;
c) 2% to 8% by weight of the nonionic surfactant;
d) 6% to 15% by weight of the copolymer comprising
i) a mono- or polyunsaturated carboxylic acid monomer; and
ii) a monomer of the general formula R¹(R²)C═C(R³)—X—R⁴, in which R¹ to R³, mutually independently, denote —H, —CH₃, or —C₂H₅, X denotes an optionally present spacer group that is selected from —CH₂—, —C(O)O—, and —C(O)—NH—, and R⁴ denotes a straight-chain or branched saturated alkyl residue having 2 to 22 carbon atoms or an unsaturated, optionally aromatic residue having 6 to 22 carbon atoms;
e) 0.1% to 0.9% by weight of the methylglycinediacetic acid; and
f) 1.0% to 6% by weight of an enzyme.

12. A method for washing dishes in an automatic dishwasher, comprising contacting dishes in need of washing with an automatic dishwashing agent of claim 1 in a washing cycle of an automatic dishwasher.

13. The method of claim 12, wherein no additional water softener and no additional rinse agent are dispensed into the automatic dishwasher in the course of the washing process.

14. The automatic dishwashing agent of claim 2, comprising 10% to 50% by weight of the citrate.

15. The automatic dishwashing agent of claim 14, comprising 15% to 40% by weight of the citrate.

16. The automatic dishwashing agent of claim 3, comprising 2% to 15% by weight of the sodium percarbonate.

17. The automatic dishwashing agent of claim 16, comprising 4% to 12% by weight of the sodium percarbonate.

18. The automatic dishwashing agent of claim 6, comprising 2% to 7% by weight of the nonionic surfactant.

19. The automatic dishwashing agent of claim 18, comprising 3% to 6% by weight of the nonionic surfactant.

20. The automatic dishwashing agent of claim 7, comprising 6% to 15% by weight of the copolymer d).

21. The automatic dishwashing agent of claim 20, comprising 6% to 12% by weight of the copolymer d).
